(19) United States
(12) Patent Application Publication
(10) Pub. No.: US 2026/0326659 A1
(43) Pub. Date: Oct. 22, 2026

(54) VEHICLE ILLUMINATION DEVICE

(71) Applicant: HONDA MOTOR CO., LTD., Tokyo (JP)

(72) Inventors: Masayoshi TAKORI, Saitama (JP); Yuji TSUCHIYA, Saitama (JP)

(21) Appl. No.: 19/105,819

(22) PCT Filed: Aug. 30, 2023
(86) PCT No.: PCT/JP2023/031437

§ 371 Date: Feb. 24, 2025

(30) Foreign Application Priority Data
Sep. 14, 2022 (JP) 2022-146572

(51) Int. Cl. B60Q 1/14; F21S 41/663; F21W 102/13

(52) U.S. Cl. CPC B60Q 1/1415; F21S 41/663; B60Q 2300/054; F21W 2102/13

(57) ABSTRACT

This vehicle illumination device comprises: a low beam irradiation unit that irradiates a bottom irradiation region in front of and below the vehicle; a high beam irradiation unit that irradiates a top irradiation region that is above and more to the center side in the vehicle width direction than the bottom irradiation region; and a variable pattern irradiation unit that irradiates, in the form of a changeable irradiation pattern, a lateral top irradiation region, which is a lateral region outside the top irradiation region in the vehicle width direction and above the bottom irradiation region. In one aspect, the variable pattern irradiation unit is changed such that the irradiation pattern takes the form of a first irradiation pattern or a second irradiation pattern in accordance with whether the high beam irradiation unit is lighted on or off.

### TECHNICAL FIELD

The present invention relates to a vehicle illumination device.

### BACKGROUND ART

As a vehicle illumination device, a device has been proposed which enable a driver to favorably visually recognize pedestrians while suppressing dazzling of pedestrians (for example, refer to Patent Document 1). The vehicle illumination device of Patent Document 1 is configured so as to reduce (set to zero) the illumination amount onto the upper body of a pedestrian according to the distance to the pedestrian acquired by a pedestrian detection sensor.

### CITATION LIST

### Patent Document

Patent Document 1: Japanese Unexamined Patent Application, Publication No. 2013-184614

### DISCLOSURE OF THE INVENTION

### Problems to be Solved by the Invention

However, with the technology of Patent Document 1, although dazzling on the side of the pedestrian is suppressed, there is concern over the visibility of the pedestrian seen from the driver's perspective being insufficient.

The present invention has been made taking account of the aforementioned such situation, and has an object of providing a vehicle illumination device which can improve overlooking of pedestrians by drivers, even under adverse conditions such as rainy weather at nighttime. It is also an object to contribute to the development of a sustainable transport system which further improves the safety of intersections.

### Means for Solving the Problems

(1) A vehicle illumination device includes: a low-beam irradiator (for example, the low-beam unit 7 described later) that irradiates a lower irradiation region (for example, the low-beam irradiation region 11 described later) on a lower side ahead of a vehicle; a high-beam irradiator (for example, the high-beam unit 6 described later) that irradiates an upper irradiation region (for example, the high-beam irradiation region 10 described later) which is more upwards and more to a central side in a vehicle width direction than the lower irradiation region; and a variable pattern irradiator (for example, the projector unit 8 described later) that irradiates, in a form that can vary an irradiation pattern, a lateral upper irradiation region (for example, the right-side pattern irradiation region 12 described later) which is a side region that is more to an outer side in the vehicle-width direction than the upper irradiation region, and more upwards than the lower irradiation region.

(2) In the vehicle illumination device of (1), the variable pattern irradiator varies a form of the irradiation pattern according to whether the high-beam irradiator is illuminated.

(3) In the vehicle illumination device of (1) or (2), the variable pattern irradiator is configured to switch between two or more types of irradiation patterns including a first irradiation pattern (for example, the first irradiation pattern 15 described later) in which a bright region (for example, the bright region 13 described later) and a dark region (for example, the dark region 14 described later) are alternately repeated, and a second irradiation pattern (for example, the second irradiation pattern 16 described later) which is a monotone bright region, and switches to any irradiation pattern according to a travel situation of one's own vehicle.

Effects of the Invention

With the vehicle illumination device of (1), by the light irradiation from the variable pattern irradiator in an irradiation pattern in which a bright region and a dark region are alternately repeated, the presence of a pedestrian on the roadside is easily recognized by the driver by the visual characteristic of humans. Even under adverse conditions such as rainy weather at nighttime, it is possible to improve the overlooking of pedestrians by the driver. On the other hand, in the case of the possibility of a pedestrian being present on the roadside being very low as on an expressway, it is possible to change the irradiation pattern from the variable pattern irradiation section, and enhance visibility in the far field of view. In addition, this in turns leads to contribute to the development of a sustainable transport system which further improves the safety of intersections.

With the vehicle illumination device of (2), it becomes possible to reduce the form of the irradiation pattern of the variable pattern irradiator to a form avoiding overlap of the irradiation region between the high-beam irradiator and the variation irradiator, and thus the power consumption of the variable pattern irradiator can be reduced.

With the vehicle illumination device of (3), for example, upon traveling on a road such as a single-lane road section, when irradiating light of the first irradiation pattern in which a bright region and a dark region are alternately repeated from the variable pattern irradiator, the driver can recognize the presence of a pedestrian by the visual characteristic of humans. On the other hand, upon traveling on a road on which the possibility of a pedestrian being present on a roadside is very low such as an expressway, when irradiating light of the second irradiation pattern, which is a monotone bright region, the irradiation region expands so as to supplement a lateral region of the high-beam irradiation region, whereby the visibility in the far field of view can be improved.

### BRIEF DESCRIPTION OF THE DRAWINGS

FIG. 1 is a schematic diagram showing an aspect of irradiation of illumination light by a vehicle illumination device according to an embodiment of the present invention;

FIG. 2 is a block diagram of the vehicle illumination device according to an embodiment of the present invention;

FIG. 3 is a view showing an irradiation region of each lamp in the vehicle illumination device in FIG. 2;

FIG. 4 is a view showing an irradiation region of a lamp in a case of the vehicle illumination device in FIG. 2 operating in a low-beam mode;

FIG. 5 is a view showing an example of an irradiation region of a lamp in a case of the vehicle illumination device in FIG. 2 operating in a high-beam mode;

FIG. 6 is a view showing another example of an irradiation region of a lamp in a case of the vehicle illumination device in FIG. 2 operating in the high-beam mode;

FIG. 7 is a view showing an example of an irradiation pattern by a variable pattern irradiation section of the vehicle illumination device in FIG. 2; and

FIG. 8 is a view showing another example of an irradiation pattern by the variable pattern irradiation section of the vehicle illumination device in FIG. 2.

### PREFERRED MODE FOR CARRYING OUT THE INVENTION

Hereinafter, an embodiment of the present invention will be described while referencing the drawings. It should be noted that, in the following description, irradiation region is the irradiation area of light by the lamp, and irradiation pattern is a design by a bright region and a dark region of the irradiation region, contour shape of the irradiation region, or other irradiation form.

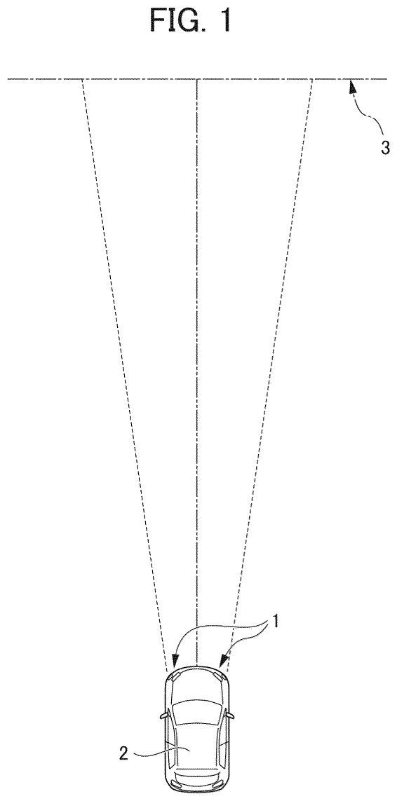

FIG. 1 is a schematic diagram showing an aspect of irradiation of illumination light by a vehicle illumination device 1 according to an embodiment of the present invention. The distribution of irradiation light from the vehicle illumination device 1 is evaluated according to an irradiation pattern formed on a test screen 3, which is a predetermined virtual vertical plane established ahead of the front of the vehicle illumination device 1 provided to a vehicle 2, for example, 25 m ahead.

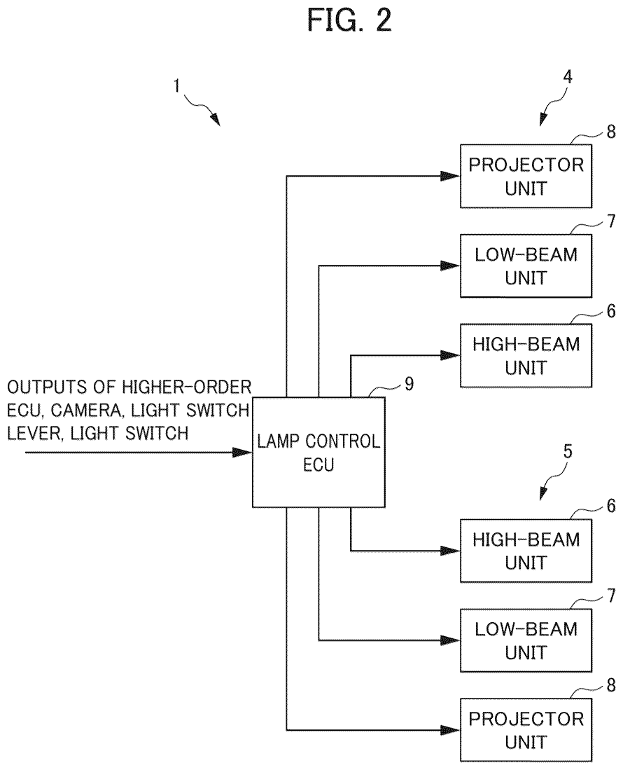

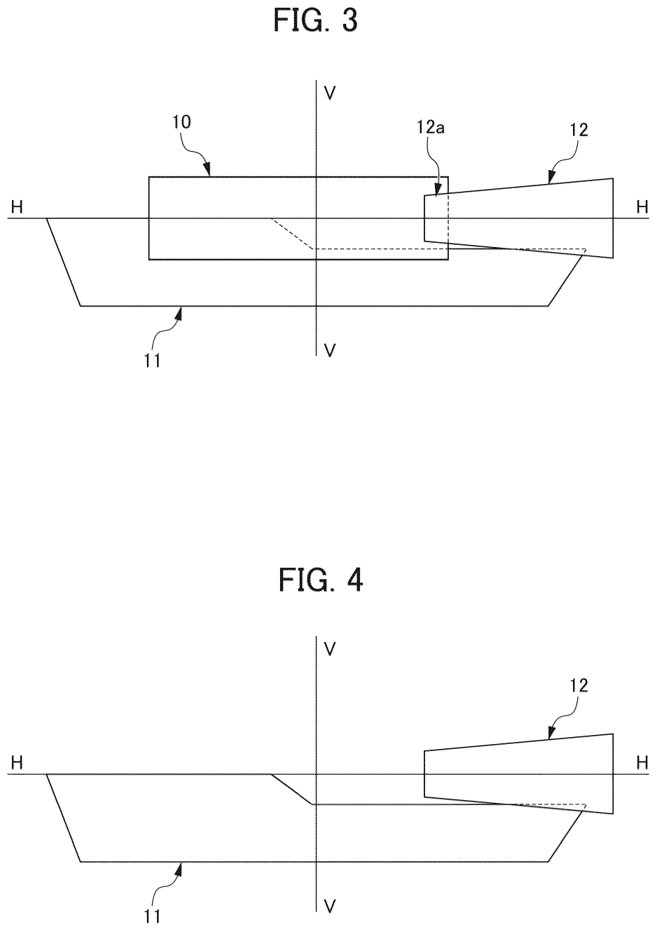

FIG. 2 is a block diagram of the vehicle illumination device 1, and FIG. 3 is a view showing the irradiation region of each lamp of the vehicle illumination device 1. In each of a left-side headlight unit 4 and a right-side headlight unit 5, which are lamps, a high-beam unit 6, a low-beam unit 7 and a projector unit 8 are arranged in order from the inner side to the outer side in the vehicle-width direction of the vehicle 2. In each of the left-side headlight unit 4 and the right-side headlight unit 5, the high-beam unit 6, the low-beam unit 7 and the projector unit 8 operate under the control of a lamp control ECU 9.

The high-beam unit 6 includes a light emitting element which is the light source, a reflector, a light shielding plate which defines the irradiation region, and a lens. The light emitting element generates light by electric power being supplied from a power source (not shown), in response to a control signal from the lamp control ECU 9. The light from the light emitting element is reflected by the reflector. The reflected light from the reflector is irradiated from the lens toward a high-beam irradiation region 10 defined by the light shielding plate.

The low-beam unit 7 includes a light emitting element which is a light source, a reflector, a light shielding plate which defines the irradiation region, and a lens. The light emitting element generates light by electric power being supplied from a power source (not shown), in response to a control signal from the lamp control ECU 9. The light from the light emitting element is reflected by the reflector. The reflected light from the reflector is irradiated from the lens towards the low-beam irradiation region 11 defined by the light shielding plate.

The projector unit 8 includes a light emitting element which is a light source, a spatial light modulator and a lens. As the spatial light modulator, for example, it is possible to utilize a modulator of a form which reflects light, while independently modulating several reflecting elements as in a DMD (Digital Micromirror Device). In this case, the projector unit 8 assumes a configuration of a DLP (Digital Light Processing: registered trademark) system using the DMD, and can irradiate light in various predetermined irradiation patterns from the lens to the front of the vehicle 2 and its surroundings.

The irradiation pattern can also assume not only still image patterns of various shapes, but also the form of a video pattern. The light emitting element generates light by driving electric power being supplied from a power source (not shown), in response to a control signal from the lamp control ECU 9. The light from this light emitting element is spatially modulated by the spatial light modulator driven according to the control signal from the lamp control ECU 9, and light is irradiated from the lens of the projector unit 8 in various predetermined irradiation patterns to the front of the vehicle 2 and its surroundings. In other words, the projector unit 8 configures a variable pattern irradiation section which can change the form of the irradiation pattern.

By referencing FIG. 3, the irradiation regions from the high-beam unit 6, the low-beam unit 7 and the projector unit 8 will be described in the case of irradiating light on the test screen 3 from the vehicle illumination device 1 of FIG. 1. Regarding the irradiation region by the projector unit 8, the irradiation region by the projector unit 8 of the right-side headlight unit 5 is shown here.

Although omitted from illustration, the irradiation region by the projector unit 8 of the left-side headlight unit 4 is symmetrical with the irradiation region by the projector unit 8 of the right-side headlight unit 5, with the line V-V as the axis of symmetry.

The configuration and operation of the projector unit 8 of the left-side headlight unit 4 are similar to the projector unit 8 of the right-side headlight unit 5. For this reason, hereinafter, the configuration and operation of the projector unit 8 of the left-side headlight unit 4 invoke the descriptions for the projector unit 8 of the right-side headlight unit 5.

The low-beam irradiation region 11 by the low-beam unit 7 has an oncoming-lane side cutoff line extending in parallel to a line H-H (horizontal line) more to the right side than the line V-V (vertical line) at the center in the left/right direction on the test screen 3. It also has an own-lane side cutoff line extending along the line H-H, more to the left side than the line V-V and at a higher position than the oncoming-lane side cutoff line. Both the oncoming-lane side cutoff line and the own-lane side cutoff line are linked by an oblique cutoff line which slopes relative to the line H-H. The low-beam irradiation region 11 is a lower irradiation region on the front lower side of the vehicle 2.

The high-beam irradiation region 10 by the high-beam unit 6 forms a rectangle having long sides parallel to the line H-H and short sides parallel to the line V-V, and an intersection of their diagonals occupy a position substantially matching the intersection of the line H-H and line V-V. The high-beam irradiation region 10 overlaps the low-beam irradiation region 11 in a lower partial region including a portion near the line V-V of each of the oncoming lane side cutoff line and the own-lane side cutoff line. The high-beam irradiation region 10 is an upper irradiation region that is more upwards than the low-beam irradiation region 11, which is the lower irradiation region, and more to the center in the vehicle-width direction of the vehicle 2.

In the right-side pattern irradiation region 12, which is the irradiation region by the projector unit 8 of the right-side headlight unit 5, the irradiation pattern is variously changed such as the contour shape of the region and the form of the irradiation pattern within this region, according to a mode switching signal from the lamp control ECU 9. However, the right-side pattern irradiation region 12 is a lateral upper irradiation region more to the outer side in the vehicle-width direction of the vehicle 2 than the upper irradiation region (high-beam irradiation region 10) and more upwards than the lower irradiation region (low-beam irradiation region 11), even in the case of assuming the any form.

In terms of the ability of the projector unit 8, the right-side pattern irradiation region 12 can assume a wide form including an overlap region 12a which overlaps with the high-beam irradiation region 10. In the case of assuming this form, the right-side pattern irradiation region 12 makes a trapezoidal shape in a landscape orientation in which the height direction is parallel to the line H-H, and the upper side and lower side are parallel to the line V-V. This trapezoid is longer at the lower side, which is relatively far from the line V-V, than the upper side, which is relatively close to the line V-V. In other words, the right-side pattern irradiation region 12 makes a shape in which the dimension along the line V-V widens as approaching the outer side in the vehicle width direction of the vehicle 2.

The lamp control ECU 9 switches the operation mode of the vehicle illumination device 1, based on the outputs from a higher-order ECU, camera, light switch, light switch lever, etc., which are not shown, equipped to the vehicle 2. In other words, the lamp control ECU 9 supplies a control signal to the high-beam unit 6, the low-beam unit 7 and the projector unit 8, and switches the operation mode of each of these units.

FIG. 4 is a view showing the irradiation region of irradiation light by the vehicle illumination device 1, in the case of the operation mode being set to the low-beam mode by the lamp control ECU 9. At nighttime, when the light switch is in the position of “auto”, and the light switch lever is at a position other than low beam, in most cases, the vehicle illumination device 1 is in the state of high-beam mode. In this state, when the camera detects oncoming vehicles, ahead vehicles or a certain number of street lights, the operation mode of the vehicle illumination device 1 is switched to the low-beam mode by the lamp control ECU 9. During low-beam mode, the high-beam unit 6 is turned off under the control by the lamp control ECU 9, the low-beam unit 7 irradiates the low-beam irradiation region 11, and the projector unit 8 irradiates the right-side pattern irradiation region 12.

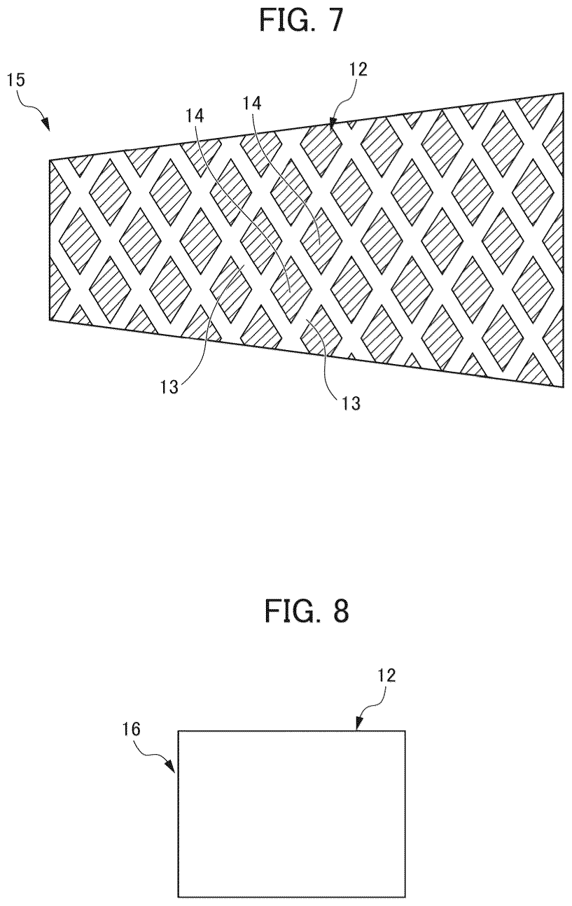

During low-beam mode, the right-side pattern irradiation region 12 occupies a wide region of trapezoidal shape in landscape orientation including the aforementioned overlap region 12a. In this wide region, the pattern irradiation light is irradiated in the first irradiation pattern 15 in which the bright regions 13 and the dark regions 14 are alternately repeated as shown in FIG. 7 from the projector unit 8. The first irradiation pattern 15 in FIG. 7 is particularly an oblique rhombus lattice pattern by the bright regions 13 of mesh pattern of the oblique rhombus lattice and the dark regions 14 surrounded by these bright regions 13.

By the irradiation light of the first irradiation pattern from the projector unit 8 of the right-side headlight unit 5, the presence of a pedestrian on the roadside is easily recognized by the driver by the visual characteristic of humans. Even under adverse conditions such as rainy weather at nighttime, it is possible to improve the overlooking of pedestrians by the driver.

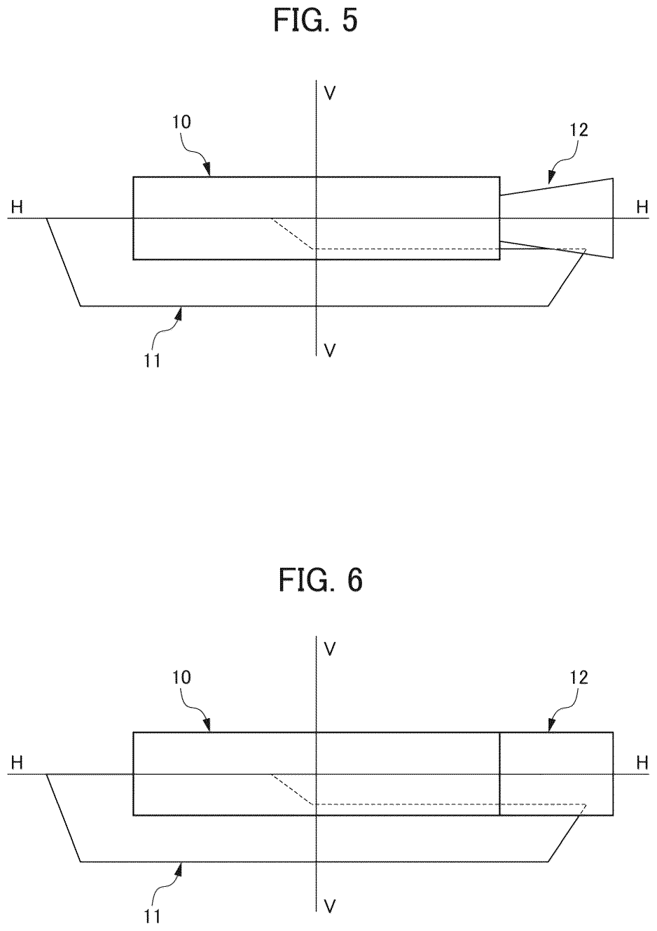

FIG. 5 is a view showing the irradiation region of irradiation light by the vehicle illumination device 1, in the case of the operation mode according to the lamp control ECU 9 being set to the high-beam mode. At nighttime, when the light switch is in the position of “auto”, and the light switch lever is at a position other than high beam, in most cases, the vehicle illumination device 1 is in the state of low-beam mode. In this state, in the case of the camera not detecting oncoming vehicles, ahead vehicles or at least a certain number of street lights, the operation mode of the vehicle illumination device 1 is switched to the high-beam mode by the lamp control ECU 9. In detail, detecting that the vehicle 2, for example, is in travel at a speed of 30 km per hour or more is also set as a prerequisite for switching to the high-beam mode by a higher-order ECU. During the high-beam mode, under the control by the lamp control ECU 9, the high-beam unit 6 irradiates the high-beam irradiation region 10, the low-beam unit 7 irradiates the low-beam irradiation region 11, and the projector unit 8 irradiates the right-side pattern irradiation region 12.

During the high-beam mode, under the control by the lamp control ECU 9, the form of the irradiation pattern of the right-side pattern irradiation region 12 by the projector unit 8 is changed in response to be high-beam unit 6 turning on. In other words, the right-side pattern irradiation region 12 is changed from a form occupying a wide region of the trapezoidal shape in landscape orientation including the overlap region 12a such as that during low-beam mode to a reduced form without the overlap region 12a and not overlapping the high-beam irradiation region 10. The scaling down of the right-side pattern irradiation region 12 is realized by establishing a more limited number of light emitting elements turned on in the projector unit 8 than during total lighting, and thus power consumption can be reduced. Also in the case of the high-beam mode, the form irradiating the pattern irradiation light can assume the first irradiation pattern shown in FIG. 7 from the projector unit 8. In the case of irradiating the pattern irradiation light in the first irradiation pattern, the presence of a pedestrian on the roadside is easily recognized by the driver by the visual characteristic of humans.

On the other hand, in the vehicle illumination device 1, if considering the aforementioned such conditions, when the high-beam mode is selected under the control by the lamp control ECU 9, there are many cases, such as traveling on expressways, where the possibility of a pedestrian being present on the roadside is very low. In such a case, the vehicle illumination device 1 of another embodiment irradiates so as to supplement the side of the high-beam irradiation region 10 by irradiation light from the projector unit 8. This aspect will be described by referencing the following FIGS. 6 and 8.

FIG. 6 is a view showing an aspect of irradiating, in the case of the operation mode of the vehicle illumination device 1 being the high-beam mode, so as to supplement a side of the high-beam irradiation region 10 by the irradiation light from the projector unit 8. In FIG. 6, the right-side pattern irradiation region 12 by the projector unit 8 forms a rectangular contour linking the right end of the high-beam irradiation region 10 so as to extend the irradiation region from the right end to the right side. The projector unit 8, as shown in FIGS. 6 and 8, irradiates the irradiation light in a second irradiation pattern 16 such that the right-side pattern irradiation region 12 forming a rectangular contour makes monotone bright region. Herein, monotone bright region is meant to include not only a case of the entire region being a bright region of the same illuminance, but also a case of having a trace of gradation.

It should be noted that the right-side pattern irradiation region 12 may be configured so as to be switchable between two or more types of irradiation patterns including the aforementioned first irradiation pattern in which the bright regions 13 and the dark regions 14 are alternately repeated, or the aforementioned second irradiation pattern, and may be configured so as to switch to any of the irradiation patterns according to the travel situation of the vehicle 2. Switching in this case is also performed under the control by the lamp control ECU 9.

The vehicle illumination device 1, which can vary the irradiation pattern in the aforementioned such right-side pattern irradiation region 12, for example, irradiates light of the first irradiation pattern from the projector unit 8, upon traveling on a road such as a single-lane road section. On the other hand, upon traveling on a road in which pedestrians are not present as on an expressway, light of the second irradiation pattern is irradiated from the projector unit 8. The switching of the irradiation pattern is performed under the control by the lamp control ECU 9 which is supplied information related to the current travel conditions of the vehicle 2 from a higher-order ECU. In the case of traveling on a road such as a single-lane road section, the first irradiation pattern is used, whereby the driver can recognize the presence of a pedestrian by the visual characteristic of humans. In addition, in the case of traveling on an expressway, the second irradiation pattern is used, and the irradiation region expands so as to supplement a lateral region of the high-beam irradiation region 10, whereby the visibility in the irradiation region in the far field of view can be improved.

According to the vehicle illumination device 1 of the present embodiment, the following effects are exerted.

(1) With the vehicle illumination device 1, when the operation mode is set to the low-beam mode by the lamp control ECU 9, the right-side pattern irradiation region 12 is irradiated by the pattern irradiation light in the first irradiation pattern 15 from a DLP (registered trademark) type projector unit 8 made using DMD, in a wide region of the trapezoidal shape in landscape orientation. The first irradiation pattern 15 is an oblique rhombus lattice pattern in which the bright regions 13 and the dark regions 14 are alternately repeated. The presence of a pedestrian on the roadside is thereby easily recognized by the driver by the visual characteristic of humans. Even under adverse conditions such as rainy weather at nighttime, it is possible to improve the overlooking of pedestrians by the driver. On the other hand, in the case of the possibility of a pedestrian being present on the roadside being very low as on an expressway, the irradiation pattern of the right-side pattern irradiation region 12 is changed to the second irradiation pattern 16 such that becomes a monotone bright region having a rectangular contour, under the control of the lamp control ECU 9, whereby the irradiation region is expanded so as to supplement the lateral region of the high-beam irradiation region 10. The visibility in the far field of view can thereby be enhanced.

(2) With the vehicle illumination device 1, the right-side pattern irradiation region 12, which is the irradiation region by the projector unit 8 under the control of the lamp control ECU 9, is reduced so as not to have the overlap region 12a with the high-beam irradiation region 10, which is the irradiation region by the high-beam unit 6. The power consumption of the variable pattern irradiation section is reduced by an amount equivalent to the overlap region 12a.

(3) With the vehicle illumination device 1, upon traveling on a road such as a single-lane road section, the driver can easily recognize the presence of a pedestrian from the visual characteristic of humans, by irradiating light of the first irradiation pattern 15 in which the bright regions 13 and the dark regions 14 are alternately repeated from the projector unit 8. On the other hand, upon traveling on a road on which the possibility of a pedestrian being present on a roadside is very low such as an expressway, when irradiating light of the second irradiation pattern 16, which is a monotone bright region, the irradiation region expands so as to supplement a lateral region of the high-beam irradiation region 10, whereby it is possible to improve the visibility in a far field of view. In other words, under the control of the lamp control ECU 9, the first irradiation pattern 15 and the second irradiation pattern 16 are applied by switching according to the travel situation of one's own vehicle, whereby the prevention of pedestrian overlooking by the driver, and a visibility improvement of the far field of view are achieved.

Although embodiments of the present invention have been described above, the present invention is not limited thereto. The configuration of detailed parts may be modified as appropriate within the scope of the gist of the present invention. The aforementioned embodiments adopted a configuration which applies the first irradiation pattern 15 and the second irradiation pattern 16 by switching therebetween according to the travel situation of one's own vehicle, under the control of the lamp control ECU 9. Instead of this, for example, it is possible to adopt a configuration in which a higher-order ECU, which always monitors the travel situation of one's own vehicle, manages operation of the projector unit 8, and applies the first irradiation pattern 15 and the second irradiation pattern 16 by switching.

### EXPLANATION OF REFERENCE NUMERALS

1 vehicle illumination device
2 vehicle
3 test screen
4 left-side headlight unit
5 right-side headlight unit
6 high-beam unit
7 low-beam unit
8 projector unit (variable pattern irradiation section)
9 lamp control ECU
10 high-beam irradiation region (upper irradiation region)
11 low-beam irradiation region (lower irradiation region)
12 right-side pattern irradiation region (lateral upper irradiation region)
12a overlap region
13 bright region
14 dark region
15 first irradiation pattern
16 second irradiation pattern

1. A vehicle illumination device comprising:
a low-beam irradiator that irradiates a lower irradiation region on a lower side ahead of a vehicle;
a high-beam irradiator that irradiates an upper irradiation region which is more upwards and more to a central side in a vehicle width direction than the lower irradiation region; and
a variable pattern irradiator that irradiates, in a form that can vary an irradiation pattern, a lateral upper irradiation region which is a side region that is more to an outer side in the vehicle-width direction than the upper irradiation region, and more upwards than the lower irradiation region,
wherein the variable pattern irradiator irradiates, during illumination of the high-beam irradiator, so that the lateral upper irradiation region undergoes a reduction to an outer side in the vehicle-width direction, relative to during no illumination of the high-beam irradiator, and
wherein, by the reduction of the lateral upper irradiation region to the outer side in the vehicle-width direction, an overlap region of the upper irradiation region and the lateral upper irradiation region is reduced relative to a case without the reduction.

2. The vehicle illumination device according to claim 1, wherein the variable pattern irradiator varies a form of the irradiation pattern according to whether the high-beam irradiator is illuminated.

3. The vehicle illumination device according to claim 1, wherein the variable pattern irradiator is configured to switch between two or more types of irradiation patterns including a first irradiation pattern in which a bright region and a dark region are alternately repeated, and a second irradiation pattern which is a monotone bright region, and switches to any irradiation pattern according to a travel situation of one's own vehicle.
